(19) United States
(12) Patent Application Publication
(10) Pub. No.: US 2017/0053480 A1
(43) Pub. Date: Feb. 23, 2017

(54) GAMES AND GAMING MACHINES HAVING 3-D ENVIRONMENT

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 15/238,824

(22) Filed: Aug. 17, 2016

Related U.S. Application Data
(60) Provisional application No. 62/206,659, filed on Aug. 18, 2015.

(51) Int. Cl. G07F 17/32; G07F 17/34

(52) U.S. Cl. CPC G07F 17/3213; G07F 17/3209; G07F 17/3246; G07F 17/34; G07F 17/3251; G07F 17/3225

(57) ABSTRACT

Games and gaming machines include a 3-D wagering game environment. A player's interaction with the 3-D game environment has an effect on the game. The player's interaction with the 3-D environment affects the probability of the player obtaining a winning outcome and/or the award for a winning outcome. As a player interacts with the 3-D wagering game environment in real time, the game dynamics change in real time, such as to change or vary the probability that a player will win or the potential award that the player might receive.

### RELATED APPLICATION DATA

This application claims priority to U.S. Provisional Application Ser. No. 62/206,659, filed Aug. 18, 2015.

### FIELD OF THE INVENTION

The present invention relates to methods of presenting and playing games and gaming machines configured to present games.

### BACKGROUND OF THE INVENTION

A variety of wagering style games are known. Originally, casino-style wagering games primarily comprised table games such as poker, roulette and craps. Eventually, slot machines or “one arm bandits” were developed. These machines were mechanically driven reel-type slot machines.

Later, electronic gaming machines were developed. These machines have been configured to offer a variety of games such as video poker and video slot games.

Gaming machine manufacturers continue to seek new ways to make the gaming machines more attractive to players. In some cases, manufacturers have developed entirely new games. In other cases, manufacturers have made changes to the actual gaming machine, such as by adding additional displays, top boxes, or other features.

As one attempt to make slot type games more exciting, manufacturers have proposed presenting game information in 3 dimensional format instead of 2 dimensional format. For example, US Publication No. 2004/0102244 discloses presenting game information in the form of 3-D reels and wheels. While these display formats may be more exciting to the player, they are still simply a different way of presenting known or existing slot games.

A new game and gaming machine is desired.

### SUMMARY OF THE INVENTION

Embodiments of the invention comprise games and gaming machines which include a 3-D game environment. In a preferred embodiment, a player's interaction with the 3-D game environment has an effect on the game. In particular, relative to implementation of the game as a wagering game, the player's interaction with the 3-D environment affects the probability of the player obtaining a winning outcome and/or the award for a winning outcome. Thus, as a player interacts with the 3-D environment in real time, the game dynamics change in real time, such as to change or vary the probability that a player will win or the potential award that the player might receive.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a gaming machine in accordance with the invention;

FIG. 2 is a flow chart which illustrates a method of presenting and playing a game in accordance with the invention; and

FIG. 3 illustrates one example of a 3-D game environment in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. In a preferred embodiment, the methods of game play and presentation are implemented via a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

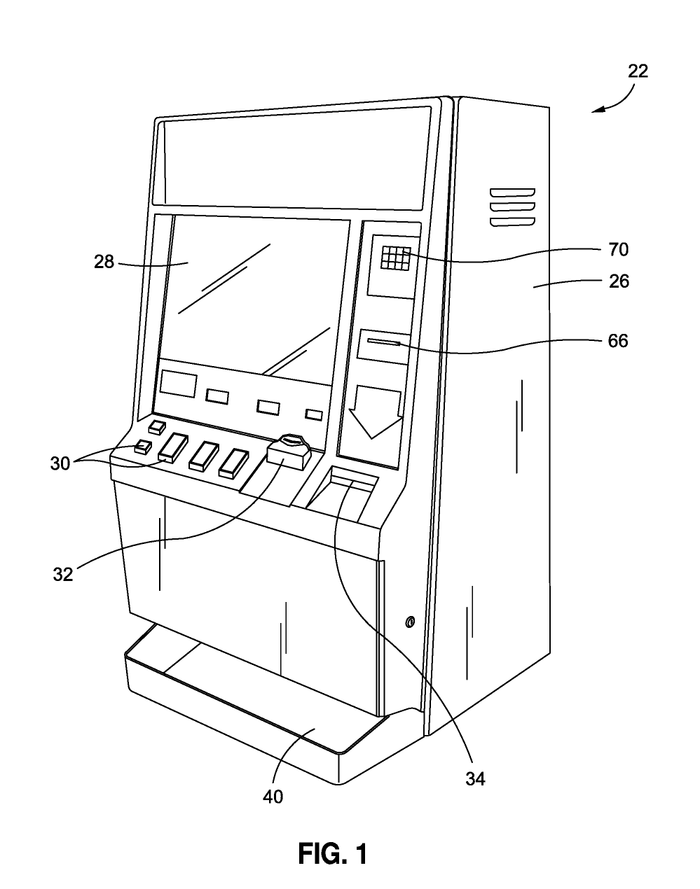

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

While the display devices may comprise one or more video displays, in another embodiment, the gaming machine 22 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

As described in more detail below, the gaming machine 22 is preferably configured to present one or more games upon a player making a monetary payment or wager. In this regard, as described in more detail below, the gaming machine 22 includes mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 22 preferably includes a mechanism or means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to “cash out” of the gaming machine, or to provide various other inputs.

In one preferred embodiment, the gaming machine 22 includes at least one microprocessor or controller for controlling the gaming machine, including receiving player input and sending output signals for controlling the various components or peripheral devices of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as a 3-D game environment, as described below), for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information, such as pay table information. The gaming machine 22 may also include one or more random number generators for generating random numbers, such as for use in generating game environment data and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions which are configured to implement the game. In this regard, the gaming machine is specially configured to present the game of the invention via specific software and/or hardware which causes the gaming machine to operate uniquely. For example, the controller of the gaming machine 22 may be configured to detect a wager, such as a signal from a player's depressing of the “bet one” button. Upon such an event and/or the player otherwise signaling the gaming machine to present the game, the controller may be configured to cause the at least one display 28 to display unique information, such as a unique graphical interface or unique game display, including game symbols or other game information. The controller may accept input from a player of game inputs, such as a request to spin reels or the like, via the one or more player input devices of the gaming machine 22. It will be appreciated that the machine readable code may be configured in various manners, such as by having various “modules” of software which are designed to implement specific features of the game play or game presentation.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOB s, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 1 is only exemplary of one embodiment of a gaming machine. For example, it is possible to for the gaming machine to have various other configurations, including different shapes and styles and having different components than as just described.

It is also possible for the game of the invention to be presented on a computing device, including at a home or office computer or a player's mobile electronic device such as a PDA, phone or the like (in this regard, the term “gaming machine” or “gaming device” is not limited to a casino gaming machine but may include other types of devices which are capable of presenting the game of the invention). In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

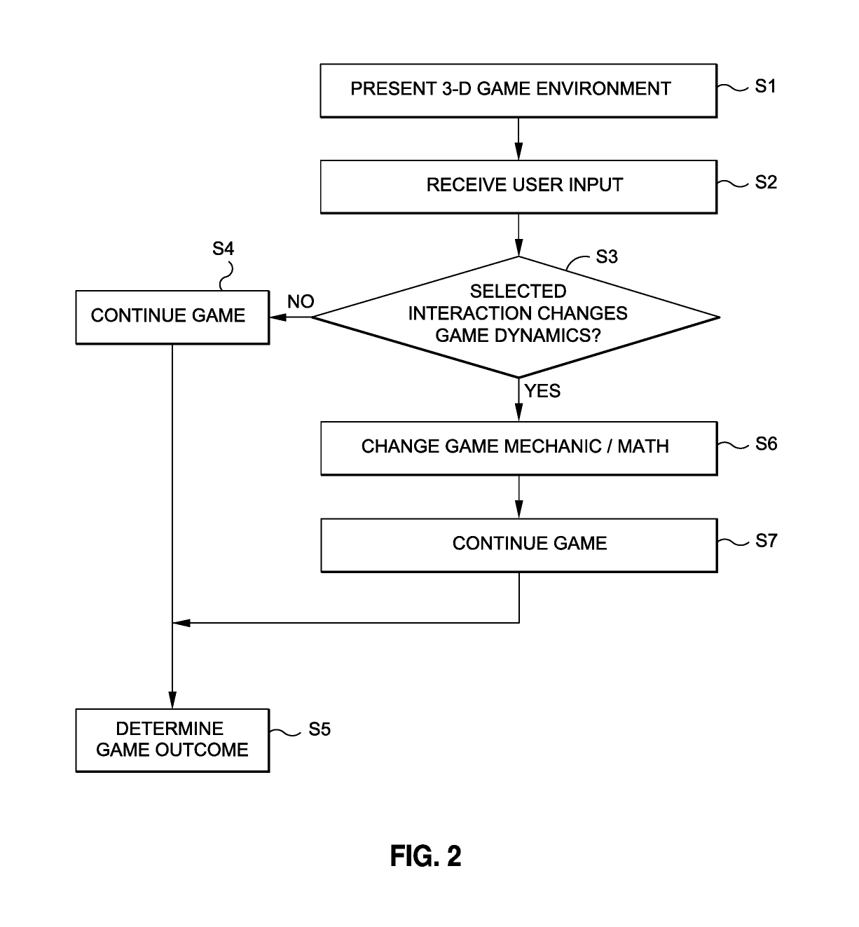

One embodiment of a method of playing and presenting a game in accordance with an embodiment of the invention will be described with reference to FIG. 2. The preferred embodiment of the invention is a game which includes a 3-D game environment. Most preferably, a player's decisions in interacting with that environment change the game dynamics, such as the game math.

As indicated in FIG. 2, in a step S1 a 3-D game environment is presented to a player. The game environment may be presented as part of a main or base game, a bonus event or other game feature.

In a preferred embodiment, a player is required to place a wager to play at least one base game. The 3-D environment may comprise an environment of the base game. Alternatively, an outcome of the base game or other events or criteria may cause the 3-D environment to be displayed to the player. For example, one or more particular base game outcomes might trigger a bonus event in which the 3-D environment is displayed. The player might or might not be required to place an additional wager (beyond the wager required to play the base game) in order to participate in the bonus game.

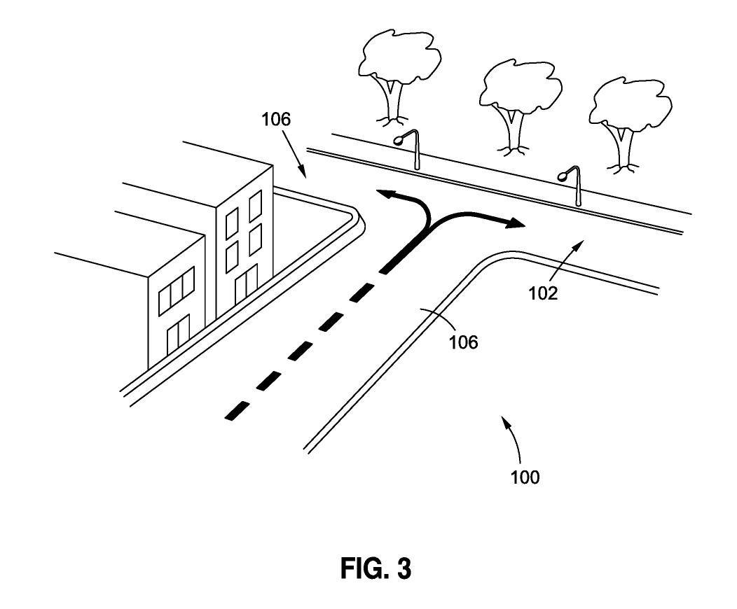

The 3-D game environment preferably comprises a three dimensional graphical representation of a gaming environment. One such environment is illustrated in FIG. 3. As illustrated, this environment comprises a three-dimensional city environment 100. The 3-D game environment may be displayed on one or more displays of the gaming machine 22. Methods for generating 3-D graphical images or interfaces are known in the computing art, and so are not described in detail herein. It will be appreciated that the 3-D environment may represent many types of environments. For example, the 3-D environment might represent a city scape, a castle, a mine, jungle, etc. Preferably, the 3-D environment presents information or views which change depending upon movement in or relative to the environment.

In a preferred embodiment, the game of the invention is configured to accept user input regarding one or more selections or choices relating to the 3-D game environment, as in a step S2. These choices may comprise, for example, an election to interact with an object in the environment or an election or selection to move to a particular area in or travel in a certain direction in, that environment. For example, referring again to FIG. 2, a player may be permitted to make an election of whether to turn right 102 or left 104 at a street intersection 106. This player input may be received by any number of input devices to the gaming machine 22.

In a preferred embodiment, different player selections relative to the 3-D game environment may change the game dynamics, such as the game's math. Thus, in a step S3, the game of the invention may involve determining if a particular player selection relative to the 3-D environment has change the game dynamics.

If not, then in a step S4, the game may continue as normal, and assuming that no other player inputs are made which change the game dynamics, the outcome of the game may be determined using a first or base game dynamic, as in a step S5.

If a player's input or selection results in a change in a game dynamic, then in a step S6, that new game dynamic is implemented. The game then continues using that dynamic, as in step S7. Again, assuming that no other player inputs are made which further change the game dynamics, the outcome of the game may be determined using the new or second game dynamic, as in step S5.

In a preferred embodiment, the “game dynamic” preferably comprises a game mechanic or math feature which changes the odds of winning and/or the payouts for winning events. For example, relative to FIG. 3, the game or event may have one or more first outcomes if the player selects the option to go right 102, and one or more second outcomes if the player selects the option to go left 104. The one or more first outcomes may comprise losing outcomes (e.g. providing no award) and/or one or more winning outcomes having associated first awards. The one or more second outcomes may comprise losing outcomes and/or one or more winning outcomes having associated second awards. In this configuration, the size of the one or more first awards (such as in the form of points, money, monetary value credits), etc., may be different than the one or more second awards. Alternatively, or in addition, the odds of receiving a winning first outcome may be different than the odds of receiving a winning second outcome.

As one example, if the player selects the option to go right 102, the 3-D environment may include the display of a first treasure chest. That first treasure chest may contain an award of 100 credits. However, if the player selects the option to go left 104, the 3-D environment may include the display of a second treasure chest. That second treasure chest may contain an award of 200 credits.

As another example, if the player selects the option to go right 102, the player might be presented with a first slot reel spin. The odds of receiving a winning outcome of that reel spin may be 50% (such as based upon the combinations of symbols associated with the reels and/or the designated winning symbol combinations). If the player selects the option to go left 104, the player might be presented with a second slot reel spin. The odds of receiving a winning outcome of that reel spin may be 75% (such as based upon the combinations of symbols associated with the reels and/or the designated winning symbol combinations).

Of course, a player might be presented with more than one option relative to the 3-D game environment, wherein each player selection may result in a change in game dynamics. For example, a player might be presented with a first selection having first and second options. Each of those selections might result in different game dynamics. If the player selected the first option, the player might then be presented with a second selection having third and fourth options. The third option might have the same game dynamics as the first option, but the fourth option might have different game dynamics (than the first option or even the second or third options).

In one embodiment, the game dynamic may be determined by an average payback or house hold for the game or event. For example, relative to wagers made by players to play the game event (whether implemented as a base game or bonus event) or relative to amount of funds allocated to the game or event, game play using a first game dynamic might result in an average payout of 97% to the player (and thus a “house hold” of 3%), while game play using a second game dynamic might result in an average payout of only 95% to the player (and thus a “house hold” of 5%). In this situation, the odds of a players winning and/or the awards paid to players is, on average, higher when player selections result in application of the first game dynamic as compared to when player selection result in application of the second game dynamic.

A particular feature of the game of the invention is that a player's interaction with the 3-D game environment has an effect on the game. In particular, relative to implementation of the game as a wagering game, the player's interaction with the 3-D environment affects the probability of the player obtaining a winning outcome and/or the award for a winning outcome. Thus, as a player interacts with the 3-D environment in real time, the game dynamics change in real time, such as to change or vary the probability that a player will win or the potential award that the player might receive.

While these game principles can be applied to a single player game, such as a single player at a single gaming machine, the principles can be applied to a multi-player game. Such a multi-player game may be presented via a gaming network, such as a network of linked gaming machines or a computing network of linked devices by which the game is presented. In this multi-player environment, multiple players may interact with the 3-D environment. Actions by one player relative to the 3-D environment may result in a change in game dynamics relative to not only that player, but other players.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a controller;
at least one electronic display;
at least one player input device;
machine-readable code executable by said controller to cause said at least one electronic display to display a three dimensional gaming environment;
machine-readable code executable by said controller to cause said controller to accept input from said player via said at least one player input device of a selection relative to said three dimensional gaming environment;
machine-readable code executable by said controller to cause said controller to change a game dynamic in response to said selection, said game dynamic changing a probability of the player receiving a winning outcome or an average award for a winning outcome;
machine-readable code executable by said controller to cause said controller to determine if said player has received a winning outcome and to award an award for a winning outcome based upon said changed game dynamic.

2. A method of presenting a wagering game to a player of an electronic gaming machine comprising the steps of:
receiving a wager from said player;
presenting a 3-D gaming environment to said player via at least one display of said electronic gaming machine;
receiving input from said player regarding an option relative to said 3-D gaming environment;
changing a game dynamic in response to said input, said game dynamic comprising a probably of said player receiving a winning outcome or an average award for a winning outcome; and
determining if said player has received a winning outcome of said game and, if so, awarding an award for said winning outcome based upon said changed game dynamic.
